(19) United States
(12) Patent Application Publication
(10) Pub. No.: US 2017/0354280 A1
(43) Pub. Date: Dec. 14, 2017

(54) METHOD AND SYSTEM FOR REGULATING THE TEMPERATURE OF A BEVERAGE

(71) Applicant: NICHOLAS PISCOTTY VENTURES, LLC., Pleasanton, CA (US)

(72) Inventor: Nicholas PISCOTTY, Pleasanton, CA (US)

(21) Appl. No.: 15/618,701

(22) Filed: Jun. 9, 2017

Related U.S. Application Data
(60) Provisional application No. 62/348,485, filed on Jun. 10, 2016.

(51) Int. Cl. A47G 19/22; A47J 41/00

(52) U.S. Cl. CPC A47G 19/2288; A47J 41/00

(57) ABSTRACT

A system for regulating a temperature of a liquid within a drinking vessel. The system including a temperature regulating device including an exterior surface and a composition disposed within a cavity, the exterior surface providing thermal communication between the composition and the liquid; and a securing element releasably securing the temperature regulating device within the vessel.

### CROSS-REFERENCE TO PRIOR APPLICATIONS

This application claims priority to U.S. Provisional Application Ser. No. 62/348,485, filed on Jun. 10, 2016, which is hereby incorporated by reference in its entirety.

### BACKGROUND

It has long been known that there are preferred temperatures for various beverages. Although most beverages are served at or near their preferred temperature, the temperature of the beverage often deviates from the preferred temperature over the duration of consumption. Other beverages, such as red wine and craft beer, are often set out at room temperature for a period of time before serving to allow the beverage to reach its preferred temperature. While the addition of ice is commonly used to modify the temperature of beverages, the dilution caused by melting ice is undesirable to use for beverages such as beer, wine, and coffee.

While there devices have been designed such as those described above designed to replace the addition of ice, there has not been an invention that is capable of tailored modification to reach nuanced preferred temperatures of beverages, such as craft beer. It is widely known that some styles of craft beer are generally preferred warmer than others and there have not been any prior devices intended to maintain the preferred temperature of particular styles of craft beer. It is common to keep different styles of craft beer in a shared refrigerator, as it is impractical, particularly for home consumers, to operate a plurality of refrigerators, each set to different temperatures. Therefore, should an individual want to consume a particular style of craft beer with a warmer preferred temperature, such as a stout, at its preferred temperature, the individual would need to wait a period of time for the beverage to warm up to its preferred temperature.

Further, some earlier devices are designed to sit in a glass without being secured or bound to the bottom in any way. As a result, when consuming the beverage, the device may move or roll around within the glass. If the device is not in the center of the glass, it may not be modulating temperature most efficiently. Alternatively, the device may fall or roll out of the glass.

### SUMMARY

An exemplary embodiment of the present invention can provide a system for regulating a temperature of a liquid within a drinking vessel. The exemplary system can include a temperature regulating device including an exterior surface and a composition disposed within a cavity, the exterior surface providing thermal communication between the composition and the liquid and a securing element releasably securing the temperature regulating device within the drinking vessel. Further, the securing element can include a magnet, and the temperature regulating device can include a second magnet which can magnetically couple to the magnet of the securing element to releasably secure the temperature regulating device within the drinking vessel. Further, the magnet can be disposed within a base of the drinking vessel. According to certain exemplary embodiments, the system can further include a coaster, and the magnet can be disposed in the coaster. Alternatively, the system can further include a koozie, and the magnet can be disposed in the koozie.

According to certain exemplary embodiments, the composition can include at least one of water, glycerin, and a mixture thereof. Further, a thermal property of the composition can be defined specifically for the liquid whose temperature is being regulated. For example, the thermal property can be defined by adjusting at least one of a volume, a component, and a concentration of the composition. The thermal property can include at least one of a freezing point and a heat capacity. Further, the exterior of the temperature regulating device can include at least one of stainless steel, aluminum, and copper.

According to certain exemplary embodiments, the temperature regulating device can be configured to warm the liquid. The temperature regulating device can also be configured to cool the liquid.

Another exemplary embodiment of the present invention can provide a system for regulating a first temperature of a first liquid and a second temperature of a second liquid. The exemplary system can include a first temperature regulating device including a first cavity and a first composition disposed therein, the first composition including a first thermal property configured to regulate the first liquid at the first temperature and a second temperature regulating device including a second cavity and a second composition disposed therein, the second composition including a second thermal property configured to regulate the second liquid at the second temperature.

The first and second thermal properties can be configured based on at least one of a volume, a component, and a concentration of the first and second compositions, respectively. Further, the first temperature and the second temperature can be different.

According to certain exemplary embodiments, each of the first and second temperature regulating devices can include a magnet configured to magnetically couple to a securing magnet to releasably secure the first and second temperature regulating devices within a drinking vessel. The securing magnet can be disposed within at least one of a base of the drinking vessel, a coaster, and a koozie.

According to certain exemplary embodiments, the first and second compositions can include at least one of water, glycerin, and a mixture thereof. Further, the first and second temperature regulating devices can be configured to warm the liquid.

### BRIEF SUMMARY OF THE DRAWINGS

FIG. 1 is an illustration of an exemplary system for controlling beverage temperature according to an embodiment;

FIG. 2 is an illustration of an exemplary device for controlling beverage temperature according to an embodiment;

FIG. 3A is a bottom view illustration of an exemplary system for controlling beverage according to an embodiment;

FIG. 3B is an illustration of an exemplary system base for controlling beverage temperature according to an embodiment;

FIG. 4 is an illustration of an exemplary system for controlling beverage temperature according to an embodiment;

FIG. 5 is an illustration of an exemplary system for controlling beverage temperature according to an embodiment;

FIG. 6 is an illustration of an exemplary system for controlling beverage temperature according to an embodiment; and

FIG. 7 is a flow diagram of an exemplary method according to an embodiment.

### DETAILED DESCRIPTION

Exemplary embodiments of the present invention generally relate to devices, systems, and methods for controlling the temperature of a beverage. Specifically, exemplary embodiments provide new and novel devices, systems, and method for controlling the temperature of a beverage.

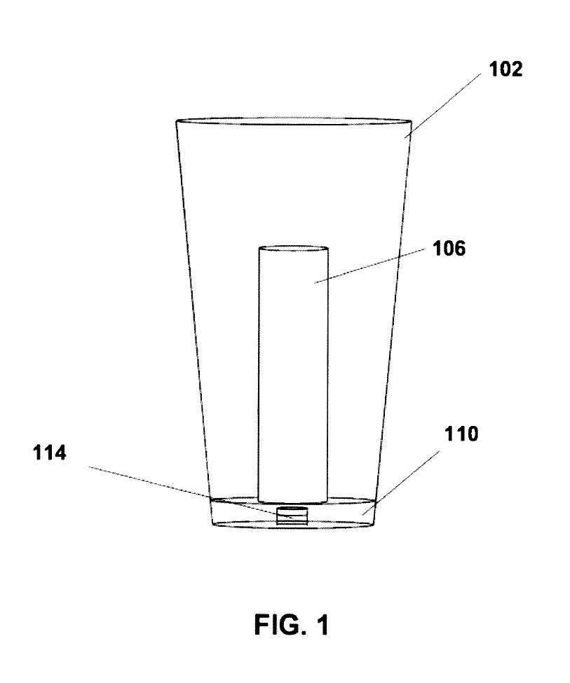

FIG. 1 shows an exemplary beverage temperature regulating system 100 according to embodiments of the present invention. FIG. 1 depicts a side view of system 100, wherein temperature regulating device 106 is disposed within drinking vessel 102 and is removably secured by a securing element, e.g., magnet 114. As shown in FIG. 1, magnet 114 can be embedded in base 110 of drinking vessel 102. Alternatively, magnet 114 can be permanently or releasably coupled to drinking vessel 102 (e.g., clips, adhesive, straps, in a releasably coupled housing, etc.). In operation, temperature regulating device 106 is preferably primed prior to submersion into the beverage whose temperature is being regulated and after it has been primed, it can be removably secured in position via magnet 114, and when a beverage (e.g., beer, wine, soda, soft drink, juice, water, etc.) is poured into drinking vessel 102, temperature regulating device 106 is immersed and surrounded by the beverage held in vessel 102 such that the internal components (e.g., a composition) of temperature regulating device 106 are in thermal communication with the beverage so as to regulate and/or control the temperature of the beverage. Further, magnet 114 secure temperature regulating device 106 in position even if vessel 102 is moved (e.g., the vessel is moved to drink from, etc.).

Priming of temperature regulating device 106 can include obtaining a primed temperature of temperature regulating device 106. For example, if a low primed temperature is desired, temperature regulating device 106 can be placed in a refrigerator, freezer, or other cold environment to lower temperature regulating device 106 to the desired primed temperature. Alternatively, if a warm primed temperature is desired, temperature regulating device 106 can be primed by allowing temperature regulating device 106 to be at room temperature, or by placing temperature regulating device 106 in warm environment (e.g., oven, etc.) to raise the temperature of temperature regulating device 106. Although temperature regulating device 106 is shown secured to base 110 of vessel 102, temperature regulating device 106 can be configured to be disposed in any portion of vessel 102 where temperature regulating device 106 can be in contact with the beverage so as to regulate and/or control the temperature of the beverage held in vessel 102.

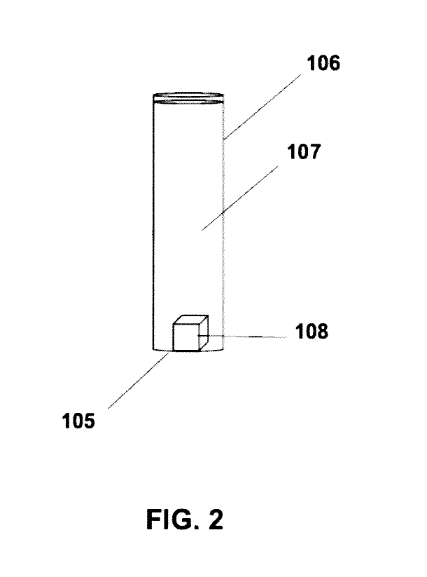

FIG. 2 shows further detail of the temperature regulating device 106. As shown in FIG. 2, temperature regulating device 106 can include composition 107 disposed with a cavity of temperature regulating device 106 and magnet 108 disposed at an end of temperature regulating device 106. Magnet 108 can magnetically couple with magnet 114 so as to releasably secure temperature regulating device 106 within vessel 102. For example, magnets 108 and 114 can releasably secure temperature regulating device 106 to a base of vessel 102 in a centered arrangement so that temperature regulating device 106 is fully immersed in the beverage, and to enable consistent and even temperature distribution throughout the beverage. Composition 107 can be in thermal communication (e.g., via an exterior of temperature regulating device 106) with the beverage, and the thermal properties of composition 107 can act to regulate the temperature of the beverage. Although temperature regulating device 106 is shown to have a cylindrical shape, temperature regulating device 106 can take any shape that includes sufficient surface area to permit composition 107 to be in thermal communication with the beverage and allow temperature regulation of the beverage. Further, composition 107 can include substances such as water, glycerin, etc., or a combination thereof, and be specifically configured to have certain desired thermal properties (e.g., freezing point, specific heat, etc.) to obtain the desired temperature regulation. For example, the volume, materials, concentrations, make-up, etc. of composition 107 can be chosen and adjusted to obtain the desired thermal properties of composition 107 so that it can properly regulate the temperature of the beverage for which it is being used.

According to certain exemplary embodiments, depending on the type of beverage whose temperature is to be regulated, temperature regulating device 106 can cool the beverage, or alternatively, temperature regulating device 106 can warm the beverage. To achieve the different desired regulated temperatures, temperature regulating device 106 can be customized to have different thermal properties for the different types of beverages. Accordingly, different liquids can have a specifically tailored temperature regulating device 106 so that the liquid can be maintained at an optimal temperature for that liquid. For example, for beverages that are to be maintained at a lower temperature, composition 107 of temperature regulating device 106 can be designed accordingly (e.g., higher specific heat, lower freezing point, etc.). According to certain exemplary embodiments, for example, a temperature regulating device specifically designed for lager beers may include a composition of approximately 3.12 cubic inches of distilled water, a temperature regulating device specifically designed for wheat beers may include a composition of approximately 2.98 cubic inches of distilled water, a temperature regulating device specifically designed for India Pale Ale (IPA) beers may include a composition of approximately 1.91 cubic inches of distilled water, a temperature regulating device specifically designed for Belgian Ale beers may include a composition of approximately 1.74 cubic inches of distilled water, and a temperature regulating device specifically designed for stout beers may include a composition of approximately 2.29 cubic inches of distilled water. Further, to allow for ease of use, the type of beverage for which each temperature regulating device is designed can be indicated on the surface of the temperature regulating device (e.g., laser etching, drawings, etc.).

The internal cavity can be sized and dimensioned to receive composition 107 and can be adjusted. Further, the internal cavity may include a larger volume than the volume of composition 107 to allow for expansion of composition 107 in the event that composition is frozen or undergoes other expansion as it is primed for use. It is readily understood that the larger the internal cavity, the more of the composition may be present, which can allow for more effective and/or a longer duration of temperature regulation.

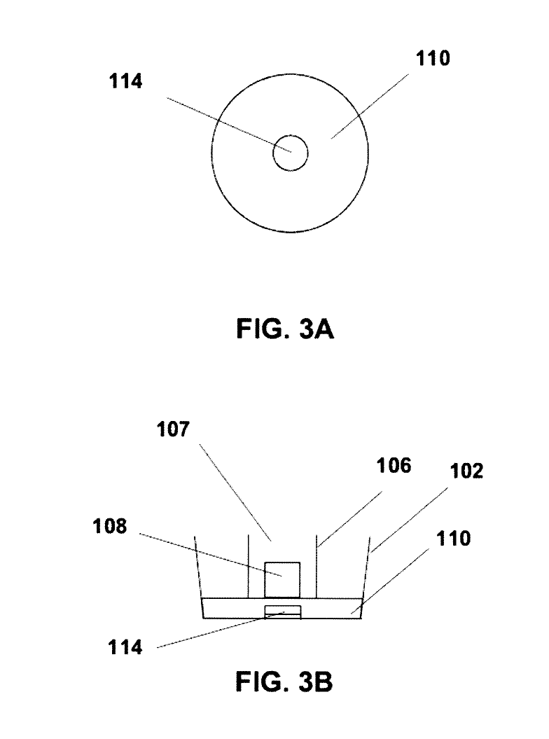

FIG. 3A shows a bottom view of base 110 of drinking vessel 102. As shown in FIG. 3A, magnet 114 may be centrally disposed within base 110 of vessel 102. In other embodiments, the magnet may be at a location other than the center. In some embodiments, there may be multiple (e.g., 2, 3, 4, 5, 6, 7, 8, 9, 10, or more) magnets affixed to various portions of drinking vessel 102 to allow temperature regulating device 106 to be releasably secured to any portion of vessel 102 that may include a magnet.

FIG. 3B shows a close-up view of beverage temperature regulating system 100 according to an embodiment of the present invention. As shown in FIG. 3, temperature regulating device 106 is releasably secured to base 110 of vessel 102 via magnetic coupling of magnets 108 and 114. Magnets 108 and 114 secure temperature regulating device 106 to the base of vessel 102 so that it does not move around within vessel 102 if someone were to move vessel 102 via an action such as taking a drink of the beverage in vessel 102. Further, composition 107 is in thermal communication with the beverage held in vessel 102 to regulate the temperature of the beverage in vessel 102 to maintain an optimal temperature for the beverage.

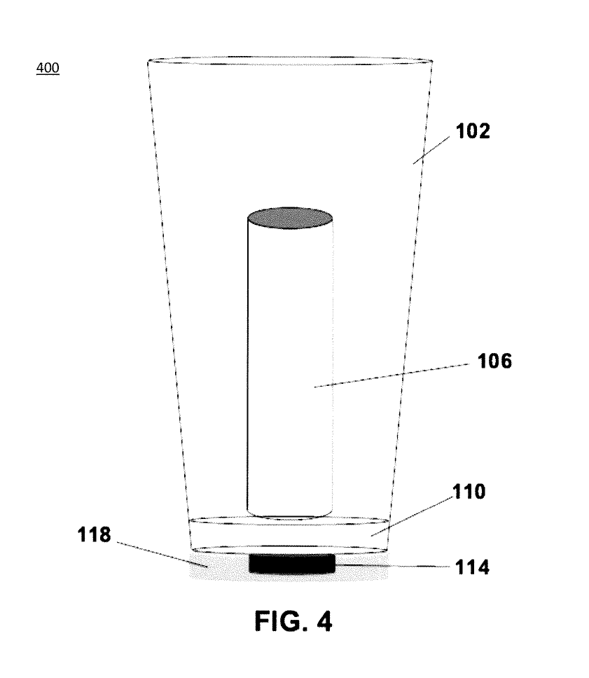

FIG. 4 shows another embodiment of a beverage temperature regulating system. The beverage temperature regulating system shown in FIG. 4 is substantially similar to beverage temperature regulating system 100 shown in FIG. 1. As shown in FIG. 4, the beverage temperature regulating system includes vessel 102 having base 110, temperature regulating device 106, and magnet 114. However, the beverage temperature regulating system shown in FIG. 4 includes coaster 118, within which magnet 114 is disposed. The beverage temperature regulating system shown in FIG. 4 operates in substantially the same manner as beverage temperature regulating system 100 shown in FIG. 1, however, instead of magnet 114 being disposed in base 110 of vessel 102, magnet 114 is disposed in coaster 118. Similar to beverage temperature regulating system 100 shown in FIG. 1, temperature regulating device 106 is releasably secured to base 110 of vessel 102 via magnetic coupling of magnet 114. Magnet 114 secures temperature regulating device 106 to the base of vessel 102 so that it does not move around within vessel 102 if someone were to move vessel 102 via an action such as taking a drink of the beverage in vessel 102. Further, coaster 118 can be removably coupled to vessel 102 such that coaster 118 need not be used if temperature regulating device 106 is not being used. Coaster 118 can be any object that can be placed under drinking vessel 102. In an embodiment, the top surface of the coaster has approximately the same dimensions or area as the bottom surface of the drinking vessel. For example, coaster 118 can be a circular disc with a 2⅜ in. diameter, so as to match the size of the base of a standard pint glass. Further, coaster 118 can include a lip around its rim to further securely engage with vessel 102. Coaster 118 may be made from any suitable material, such as glass, plastic, metal, cork, etc., or a combination thereof.

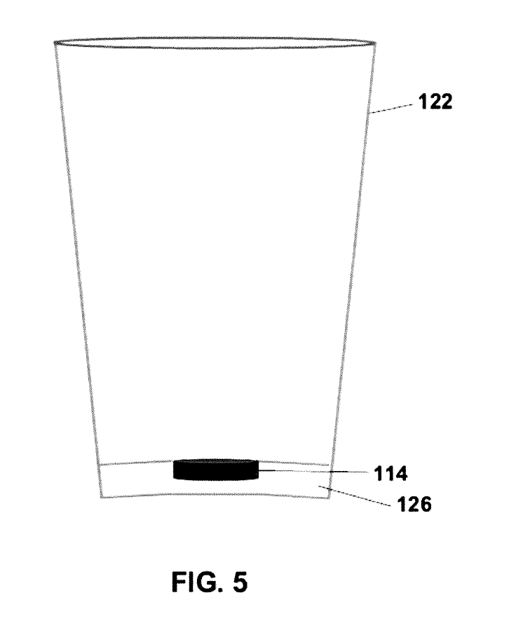

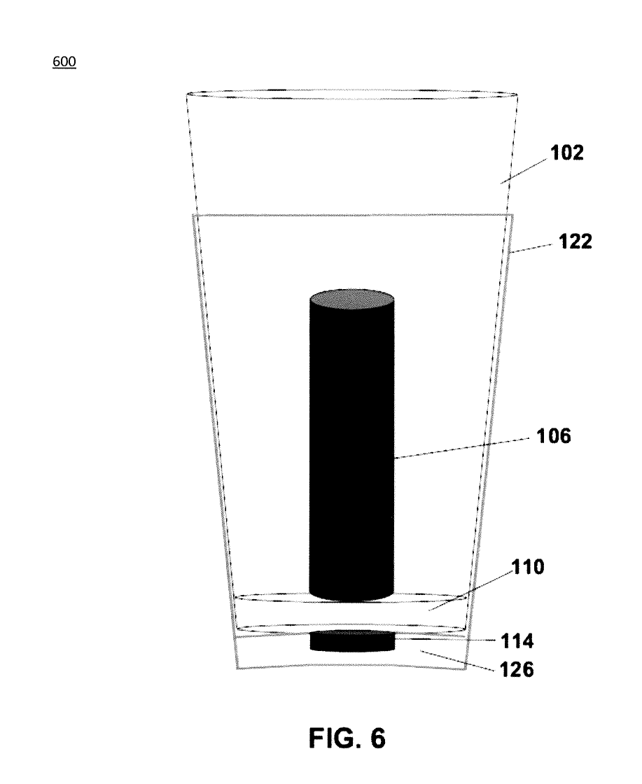

FIGS. 5 and 6 show yet another embodiment of a beverage temperature regulating system. The beverage temperature regulating system shown in FIGS. 5 and 6 is substantially similar to beverage temperature regulating system shown in FIGS. 1 and 4. As shown in FIG. 6, the beverage temperature regulating system includes vessel 102 having base 110, temperature regulating device 106, and magnet 114. However, the beverage temperature regulating system shown in FIG. 6 includes koozie 122, within which magnet 114 is disposed (e.g., in base 126 of koozie 122). The beverage temperature regulating system shown in FIGS. 5 and 6 operates in substantially the same manner as beverage temperature regulating system shown in FIGS. 1 and 4, however, instead of magnet 114 being disposed in base 110 of vessel 102 or coaster 118, magnet 114 is disposed in bas 126 of koozie 122. Similar to beverage temperature regulating system 100 shown in FIG. 1, temperature regulating device 106 is releasably secured to base 110 of vessel 102 via magnetic coupling of magnet 114. Magnet 114 secures temperature regulating device 106 to the base of vessel 102 so that it does not move around within vessel 102 if someone were to move vessel 102 via an action such as taking a drink of the beverage in vessel 102. Further, koozie 122 can be removably coupled to vessel 102 such that koozie 122 need not be used if temperature regulating device 106 is not being used. Koozie 122 can include any object adapted to receive a drinking vessel, so that the koozie is at least partially situated around the sides or walls and under the drinking vessel. Koozie 122 can be similar in shape to the vessel (e.g., cup-like), and can include a base portion, which can be underneath and in contact with the base of the drinking vessel while in use, and a side portion, which can be around and in contact with the wall of the vessel while in use. Koozie 122 can be made from any suitable material, such as, for example, acrylic, leather, neoprene, EVA, polyester, vinyl, foam, plastic, metal, etc., or a combination thereof.

Embodiments of invention can be used to regulate the temperature of a beverage. For example, embodiments of the present invention can be used to cool or warm a beverage to a desired or optimum temperature, and/or keep the beverage at that temperature for a longer period of time than would be the case in an ordinary drinking vessel without utilizing embodiments of the present invention. Accordingly, the thermal properties of composition 107, which can be in thermal communication with the beverage, can regulate the temperature of the beverage around its optical temperature.

As an example, different types of beers are best enjoyed at different ranges of temperatures. These ideal temperature ranges include about 35-40° F. (American adjunct lagers (“Macros”), malt liquors, light or low alcohol beers), about 40-45° F. (pilsner, light-bodied lagers, kolsch, Belgian wit, hefeweizen, Berliner weisse, American wheat), about 45-50° F. (pale ales, medium-bodied lagers, porters, alt, Irish stouts, sweet stouts), about 50-55° F. (sour ales, lambic/gueuze, English bitters, strong ales, Baltic porters, bocks, Scotch ales, Belgian ales, Trappist ales), and about 55-60° F. (Imperial stouts, Belgian quads, Belgian strong ales, barleywines, old ales, dopplebocks, eisbocks). (Craft Beer Temple, “Serving Beer”, http://craftbeertemple.com/videoblog/serving-beer/, accessed May 12, 2016)

For example, the freezing point of composition 107 may be tailored to have specific freezing points and/or ranges. For example, a composition of water and glycerin may be specified to have a freezing point from anywhere between −50° F. and 59° F. Any mixture with a known freezing point may be used. By selecting the elongate body that contains the composition having the desired freezing point, one is able to tailor the temperature modification of the beverage. For example, as discussed above, one may desire to have a beverage, such as a lager, served at a temperature of 35-40° F. One would select an elongate body having a composition that freezes at or near this range.

Further, if the beer is colder than the freezing point of the composition within the device, when it warms up, the device will maintain the temperature of the beer at the composition's freezing point while it melts. Some of the heat from the beer will transfer to the composition as it melts, which will reduce the rate at which the temperature of the beer rises.

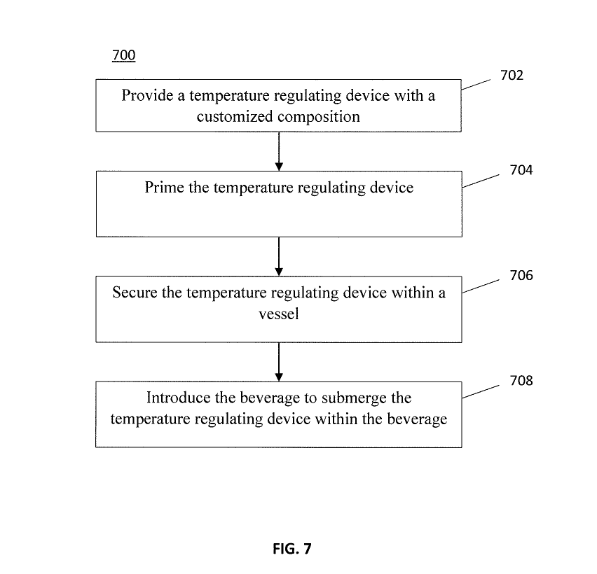

FIG. 7 shows a flow chart of an exemplary method 700 of regulating a temperature of a liquid. As shown in FIG. 7, in step 702, a temperature regulating device (e.g., temperature regulating device 106) having a customized composition with specific thermal properties specifically for the beverage whose temperature is to be regulated is provided. In step 704, the temperature regulating device is primed. For example, this can include introducing the temperature regulating device to a cold environment (e.g., refrigerator or freezer), a warm environment (e.g., an oven), a moderate environment (e.g., room temperature), etc. to ensure that the temperature regulating device is primed at the desired primed temperature. Next, in step 706, the temperature regulating device is releasably secured to a vessel (e.g., via magnets), and in step 708, the beverage is introduced to the vessel, so as to submerge the temperature regulating device and allow the temperature regulating device to regulate the temperature of the beverage via thermal communication of the temperature regulating device and the beverage.

While the invention has been illustrated and described in detail in above, such illustration and description are to be considered illustrative or exemplary and not restrictive. It will be understood that changes and modifications may be made by those of ordinary skill within the scope and spirit of the following claims. In particular, the present invention covers further embodiments with any combination of features from different embodiments described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims and list of embodiments disclosed herein. Although specific terms are employed herein, they are used in a generic and descriptive sense only and not for purposes of limitation. For the embodiments described in this application, each embodiment disclosed herein is contemplated as being applicable to each of the other disclosed embodiments.

What is claimed is:

1. A system for regulating a temperature of a liquid within a drinking vessel, comprising:
a temperature regulating device including an exterior surface and a composition disposed within a cavity, the exterior surface providing thermal communication between the composition and the liquid; and
a securing element releasably securing the temperature regulating device within the drinking vessel.

2. The system of claim 1, wherein the securing element includes a magnet.

3. The system of claim 2, wherein the temperature regulating device includes a second magnet which magnetically couples to the magnet of the securing element to releasably secure the temperature regulating device within the drinking vessel.

4. The system of claim 2, wherein the magnet is disposed within a base of the drinking vessel.

5. The system of claim 2, further comprising a coaster, and wherein the magnet is disposed in the coaster.

6. The system of claim 2, further comprising a koozie, and wherein the magnet is disposed in the koozie.

7. The system of claim 1, wherein the composition includes at least one of water, glycerin, and a mixture thereof.

8. The system of claim 1, wherein a thermal property of the composition is defined specifically for the liquid whose temperature is being regulated.

9. The system of claim 8, wherein the thermal property is defined by adjusting at least one of a volume, a component, and a concentration of the composition.

10. The system of claim 8, wherein the thermal property includes at least one of a freezing point and a heat capacity.

11. The system of claim 1, wherein the exterior of the temperature regulating device includes at least one of stainless steel, aluminum, and copper.

12. The system of claim 1, wherein the temperature regulating device is configured to warm the liquid.

13. The system of claim 1, wherein the temperature regulating device is configured to cool the liquid.

14. A system for regulating a first temperature of a first liquid and a second temperature of a second liquid, comprising:
a first temperature regulating device including a first cavity and a first composition disposed therein, the first composition including a first thermal property configured to regulate the first liquid at the first temperature; and
a second temperature regulating device including a second cavity and a second composition disposed therein, the second composition including a second thermal property configured to regulate the second liquid at the second temperature.

15. The system of claim 14, wherein the first and second thermal properties are configured based on at least one of a volume, a component, and a concentration of the first and second compositions, respectively.

16. The system of claim 14, wherein the first temperature and the second temperature are different.

17. The system of claim 14, wherein each of the first and second temperature regulating devices includes a magnet configured to magnetically couple to a securing magnet to releasably secure the first and second temperature regulating devices within a drinking vessel.

18. The system of claim 17, wherein the securing magnet is disposed within at least one of a base of the drinking vessel, a coaster, and a koozie.

19. The system of claim 14, wherein the first and second compositions include at least one of water, glycerin, and a mixture thereof.

20. The system of claim 1, wherein the first and second temperature regulating devices are configured to warm the liquid.
